(19) United States
(12) Patent Application Publication
(10) Pub. No.: US 2004/0116087 A1
(43) Pub. Date: Jun. 17, 2004

(54) Radio frequency receiver architecture with on-chip tracking intermediate frequency filtering

(75) Inventor: David H. Shen, Saratoga, CA (US)

Correspondence Address: DAVID H. SHEN, IRF Semiconductor, Inc., 6 RESULTS WAY, CUPERTINO, CA, 95014, US

(73) Assignee: IRF SEMICONDUCTOR, INC.

(21) Appl. No.: 10/729,662

(22) Filed: Dec. 5, 2003

Related U.S. Application Data
(60) Provisional application No. 60/431,971, filed on Dec. 10, 2002.

(51) Int. Cl. H04B 1/00; H04B 1/18

(52) U.S. Cl. 455/130; 455/196.1; 455/182.1

(57) ABSTRACT

A RF communications receiver is disclosed which permits greater integration on standard silicon chips and consumes less power than previous receivers. A new method for using a tracking intermediate frequency filter for a variable intermediate frequency receiver ensures good performance over an entire received frequency band.

(Based on the Provisional Application No. 60/431,971)

THIS APPLICATION IS BASED ON THE PROVISIONAL APPLICATION No. 60/431,971 FILED ON Dec. 10, 2002

### BACKGROUND

1. Technical Field of Invention

The present invention relates to radio receivers and methods for the reception of RF (radio frequency) communication signals in multiple frequency bands. In particular, it relates to integrated circuit based radio receivers using programmable on-chip tuning.

2. Background of the Invention and Discussion of Prior Art

At the present time, the vast majority of RF communication receivers are of the superheterodyne type. This type of receiver uses one or more IF (intermediate frequency) stages for filtering and amplifying signals at a fixed frequency within an IF chain. This radio architecture has the advantage that fixed filters may be used in the LO chain. In order for the receiver to be useable over multiple bands, its typical architecture is as the single-band receiver shown in FIG. 1. An RF signal arriving at an antenna 11 passes through a band-select RF filter 13, an LNA (low noise amplifier), 15, and into an image filter, 17, which produce a band-limited RF signal. This band-limited RF signal then enters the first mixer 19, which translates the RF signal down to an intermediate frequency by mixing it with the signal produced by the first LO (local oscillator) 21. The undesired mixer products in the IF signal are rejected by an IF filter, 23. The filtered IF signal then enters an IF amplifier stage, 25, after which the outputs feeds into the second mixer 27 which translates it down to yet another intermediate frequency by mixing it with the signal produced by a second LO, 28. The signal is then sent to the baseband for processing. Tuning into a particular channel within the band-limited RF signal is accomplished by varying the frequency of each LO, 21 and 28.

In order to reduce size, power consumption, and cost, it would be advantageous to integrate the electronic components of radio receiver and transmitter to reduce the number of filters and mixers. The superheterodyne design, however, requires high quality, narrowband IF bandpass filters that are typically implemented off-chip. These filtering components impose a lower limit to the size, materials cost, assembly cost, and power consumption of receiver and transmitter built using the superheterodyne design. Moreover, the necessity for mixer and local oscillator circuits operating at high frequencies contributes greatly to the power consumption and general complexity of the superheterodyne receiver. In particular, the high-frequency analog mixers require a large amount of power to maintain linear operation. Although many variations of the superheterodyne design exist, they all share the limitations of the particular design just described.

The growing demand for portable communications has motivated attempts to design radio receivers that permit the integration of more components onto a single chip. Recent advances in semiconductor processing of inductors are allowing more and more of these filters to be implemented on-chip.

A second receiver design is the direct-conversion, or zero-IF, receiver shown in FIG. 2. An antenna 57 couples a RF signal through a first bandpass RF filter, 59, into a LNA, 61. The signal then proceeds through a second RF filter 63, yielding a band-limited RF signal, which then enters a mixer, 65, and mixes with an LO frequency produced by an LO, 67. Up to this point, the direct-conversion receiver design is essentially the same as the previous receiver design. Unlike the previous designs, however, the LO frequency is set to the carrier frequency of the RF channel of interest. The resulting mixer product is a zero-frequency IF signal—a modulated signal at baseband frequency. The mixer output, 67, is coupled into a lowpass analog filter 69 before proceeding into baseband information signal for use by the remainder of the communications system. In either case, tuning is accomplished by varying the frequency of LO, 67, thereby converting different RF channels to zero-frequency IF signals.

Because the direct-conversion receiver design produces a zero-frequency IF signal, its filter requirements are greatly simplified—no external IF filter components are needed since the zero-IF signal is an audio frequency signal that can be filtered by a low-quality low-pass filter. This allows the receiver to be integrated in a standard silicon process from mixer 65 onwards, making the direct-conversion receiver design potentially attractive for portable applications.

The direct-conversion design, however, has several problems, some of which are quite serious. As with the other designs described above, the RF and image filters required in the direct-conversion design must be high-quality narrowband filters that must remain off-chip. Moreover, this design requires the use of high-frequency mixer and LO circuits that require large amounts of power. Additionally, radiated power from LO, 67, can couple into antenna 57, producing a DC offset at the output of mixer, 65. This DC offset can be much greater than the desired zero-IF signal, making signal reception difficult. Radiated power from LO 67 can also affect other nearby direct-conversion receivers tuned to the same radio frequency.

In summary, although the prior art includes various receiver designs, each one has significant disadvantages including one or more of the following: the necessity for several external circuit components, the consumption of large amounts of power, poor signal reception, poor selectivity, distortion, and limited dynamic range.

### OBJECTS AND ADVANTAGES OF THE INVENTION

Accordingly, it is a primary object of the present invention to provide a multiple frequency band radio receiver design, which has increased integration and decreased power consumption without the operational problems associated with previous receiver designs. It is a further object of the invention to provide an equivalent performance to the traditional multi-band superheterodyne receiver of FIG. 1.

### SUMMARY OF THE INVENTION

The present invention achieves the above objects and advantages by providing a new method for RF communications signal reception for the receiver design. This method uses a variable intermediate frequency, tracked by an on-chip intermediate frequency filtering. The highly integrated solution allows for significant cost savings, board area savings, and power savings compared to prior art solutions.

### DESCRIPTION OF DRAWINGS

FIG. 1 is a block diagram of a dual-band superheterodyne receiver considered as prior art.

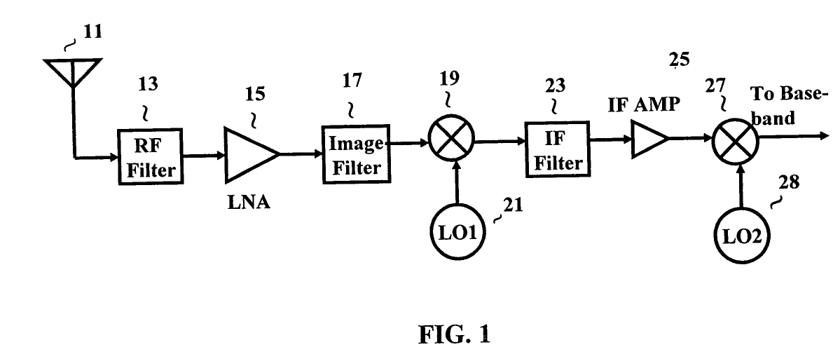

FIG. 2 is a block diagram of a direct-conversion receiver considered as prior art.

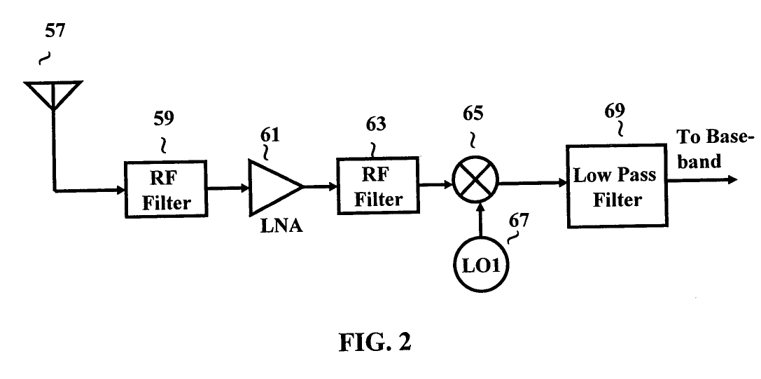

FIG. 3 is a block diagram of a receiver constructed with the principles of the invention.

FIG. 4 is an example of an implementation the tracking intermediate frequency filter.

### DESCRIPTION OF THE PREFERRED EMBODIMENT

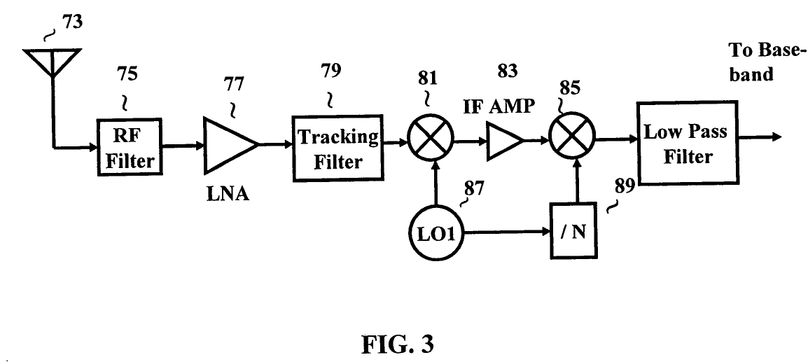

FIG. 3 is a block diagram of a RF communication receiver constructed in accordance with the principles of the present invention. It includes an antenna 73 for coupling a RF signal into the input of a bandpass RF filter, 75. The output of the analog bandpass RF filter, 75, connects to the input of an LNA, 77, whose output couples to the input of a tracking image rejection filter, 79. The output of the tracking image rejection filter, 79, is mixed with the first local oscillator, 87, through the mixer, 81. At the output of the mixer, 81, the desired signal is frequency translated to a variable intermediate frequency that is coupled into the input of an intermediate frequency amplifier, 83. The output of the intermediate frequency amplifier, 83, is an input to a second mixer, 85, that mixes with a divided version of the local oscillator, 87, to frequency translate the desired signal to baseband. The frequency divider, 89, divides the frequency of the first local oscillator, 87, to form a second local oscillator frequency that tracks the first local oscillator. This causes the intermediate frequency to be variable. In order for the on-chip image filter, 79, to effective suppress the image frequencies of a variable intermediate frequency, its center frequency should vary with the local oscillator, 87. The tracking intermediate frequency filter ensures the best image rejection for the unwanted image signal regardless of the value of the variable intermediate frequency. This method guarantees high performance throughout the frequencies of the received band. The generation of the second local oscillator frequency through frequency divider, 89, is more power efficient and with lower noise than utilizing a standard second local oscillator.

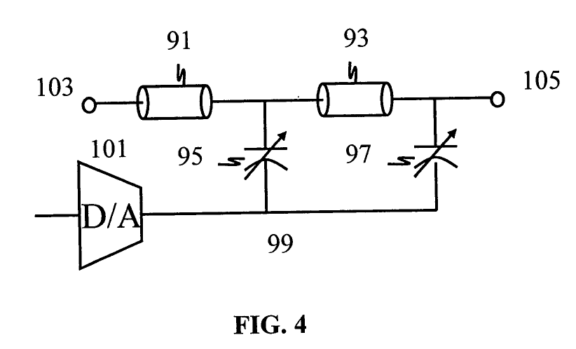

FIG. 4 gives a possible implementation of the tracking image rejection filter, 79, in a form that can be implemented with on-chip inductors, 91 and 93, and capacitors, 95 and 97, which can be adjusted with a control voltage, 99. The control voltage, 99, can be generated by a digital-to-analog converter, 101, or through other analog means in order to track the change of frequency of the local oscillator, 87. The capacitors, 95 and 97, can easily be implemented on chip by junction varactors or MOS varactors. The voltage input of the tracking image rejection filter, 103, is filtered to produce voltage output, 105. The frequency response of the tracking image rejection filter, 79, can be band-pass, band-stop, low-pass or high-pass. A band-stop filter provides the highest rejection response to specific interferers, while a band-pass filter provides rejection of both low and high frequency images. Those skilled in the art will recognize that many tracking image filter, 79, responses and topologies can be implemented, and those responses are within the scope of this patent. The tracking image filter, 79, can be implemented as a single-ended or differential circuit. These and other modifications, which are obvious to those skilled in the art, are intended to be included within the scope of the present invention. Accordingly, the scope of the invention should be determined not by the embodiment described, but by the appended claims and their legal equivalents.

1. A method for a highly integrated radio receiver design comprising of
a low noise amplifier with an output connected to
an image rejection filter with the ability to be tuned to track a variable intermediate frequency, the output of the image rejection filter connected to
a mixer whose second input is connected to a first local oscillator frequency and whose output is connected to
an intermediate frequency amplifier stage whose output is connected to
a second mixer with a second input connected to
a second local oscillator frequency, which is a frequency divided version of the first local oscillator. The output of the second mixer is connected to a baseband low-pass filter for channel-select filtering.

2. The method of claim 1 wherein the second local oscillator stage consists of an in-phase and quadrature mixer to produce independent in-phase and quadrature baseband signals.

3. The method of claim 1 wherein the intermediate frequency amplifier stage is replaced with an intermediate frequency filter stage.

4. The method of claim 1 wherein the intermediate frequency filter stage is followed by an intermediate frequency filter stage.

5. The method of claim 1 wherein the second local oscillator frequency is an integral divisor of the first local oscillator frequency.

6. The method of claim 1 wherein the second local oscillator frequency is a fractional divisor of the first local oscillator frequency.

7. The method of claim 1 wherein the LNA is an external component to the RF chip.

8. The method of claim 1 wherein the image rejection filter is a external component to the RF chip.

9. The method of claim 1 wherein the said image filters are integrated resonant elements on the RF chip.

10. The method of claim 1 wherein the receiver is implemented with CMOS technology.

11. The method of claim 1 wherein the receiver is implemented in bipolar technology.

12. The method of claim 1 wherein the receiver is implemented in any integrated circuit technology.

13. The method of claim 1 wherein there a multiple LNA front-ends and multiple image rejection filters for multiple input frequency bands.
